(19) United States
(12) Patent Application Publication
(10) Pub. No.: US 2026/0095218 A1
(43) Pub. Date: Apr. 2, 2026

(54) COMMUNICATION SYSTEM AND ANTENNA SELECTION METHOD THEREOF

(71) Applicant: REALTEK SEMICONDUCTOR CORPORATION, Hsinchu (TW)

(72) Inventors: CHIH-HENG TSAI, Hsinchu (TW); Wei-Hsuan Chang, Hsinchu (TW); Yi-Tang Chiu, Hsinchu (TW)

(21) Appl. No.: 19/323,164

(22) Filed: Sep. 9, 2025

(30) Foreign Application Priority Data
Sep. 27, 2024 (TW) 113136973

(51) Int. Cl. H04B 7/06; H04B 1/40; H04B 17/336; H04B 17/382; H04L 5/00

(52) U.S. Cl. CPC H04B 7/0608; H04B 17/336; H04L 5/0048; H04B 1/40; H04B 17/382

(57) ABSTRACT

A communication system includes a transceiver circuit and a controller circuit. The transceiver circuit sequentially transmits first and second trigger frames to an electronic device, so that the electronic device uses a first number of spatial streams to transmit a first packet in response to the first trigger frame, and uses a second number of spatial streams to transmit a second packet in response to the second trigger frame. The transceiver circuit receives the first packet via a first antenna group and receives the second packet via a second antenna group. The controller circuit determines first channel information according to the first packet, determines second channel information according to the second packet, and selects a corresponding antenna group from those two antenna groups according to the first and second channel information, to receive data from the electronic device via the corresponding antenna group.

### BACKGROUND OF THE INVENTION

### 1. Field of the Invention

The present disclosure relates to a communication system, especially to a communication system that uses trigger frames to accelerate antenna selection and an antenna selection method thereof.

### 2. Description of Related Art

In existing related approaches, when a communication device has multiple antennas, the communication device needs to use different antenna combinations to collect related signals returned from the device end over a relatively long period, and perform statistical analysis on all signals received during that period to select the antenna to be used subsequently. As such, a longer processing time is spent on information collection and statistical analysis, which lowers the efficiency of antenna selection.

### SUMMARY OF THE INVENTION

In some aspects of the present disclosure, an object of the present disclosure is to provide, but not limited to, a communication system and an antenna selection method there of that are able to use trigger frame(s) to improve the processing efficiency of antenna selection, so as to make an improvement to the prior art.

In some aspects of the present disclosure, a communication system includes a transceiver circuit and a controller circuit. The transceiver circuit is configured to sequentially transmit a first trigger frame and a second trigger frame to an electronic device, so that the electronic device uses a first number of spatial streams to transmit a first packet in response to the first trigger frame, and uses a second number of spatial streams to transmit a second packet in response to the second trigger frame, in which the transceiver circuit receives the first packet via a first antenna group and receives the second packet via a second antenna group. The controller circuit is configured to determine first channel information corresponding to the first antenna group according to the first packet, determine second channel information corresponding to the second antenna group according to the second packet, and select a corresponding antenna group from the first antenna group and the second antenna group according to the first channel information and the second channel information, so as to receive data from the electronic device via the corresponding antenna group.

In some aspects of the present disclosure, an antenna selection method includes the following operations: sequentially transmitting a first trigger frame and a second trigger frame to an electronic device, so that the electronic device uses a first number of spatial streams to transmit a first packet in response to the first trigger frame, and uses a second number of spatial streams to transmit a second packet in response to the second trigger frame; receiving the first packet via a first antenna group; receiving the second packet via a second antenna group; determining first channel information corresponding to the first antenna group according to the first packet; determining second channel information corresponding to the second antenna group according to the second packet; and selecting a corresponding antenna group from the first antenna group and the second antenna group according to the first channel information and the second channel information, so as to receive data from the electronic device via the corresponding antenna group.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a schematic diagram of a communication system according to some embodiments of the present disclosure.

FIG. 2 illustrates a schematic timing diagram illustrating operations of exchanging trigger frames and packets between the communication system and the electronic device in FIG. 1 according to some embodiments of the present disclosure.

FIG. 3A illustrates a flowchart illustrating an operation of the controller circuit in FIG. 1 for determining a corresponding antenna group according to the first channel information, the second channel information, and the third channel information according to some embodiments of the present disclosure.

FIG. 3B illustrates a flowchart illustrating an operation of the controller circuit in FIG. 1 for determining a corresponding antenna group according to the first channel information, the second channel information, and the third channel information according to some embodiments of the present disclosure.

FIG. 4 illustrates a flowchart illustrating an antenna selection method according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuitry” may indicate a system formed with at least one circuit, and the term “circuit” may indicate an object, which is formed with one or more transistors and/or one or more active/passive elements according to a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, like elements in various figures are designated with the same reference number.

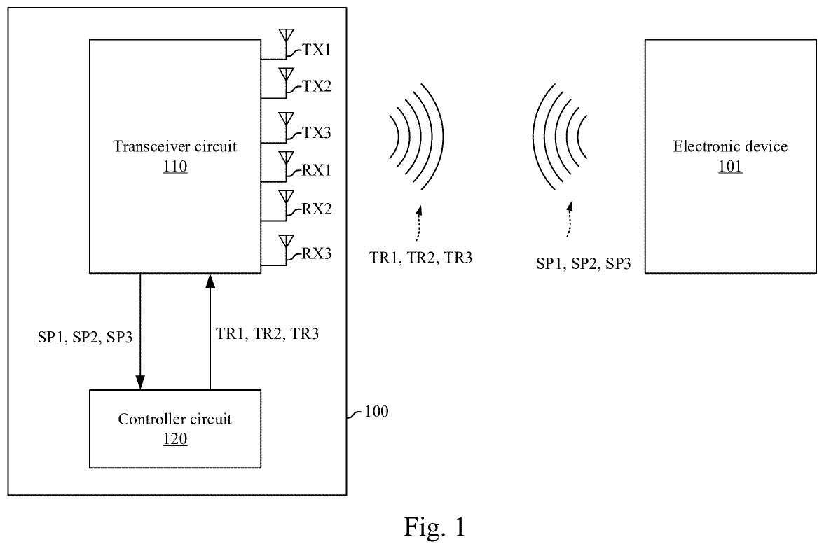

FIG. 1 illustrates a schematic diagram of a communication system 100 according to some embodiments of the present disclosure. In some embodiments, the communication system 100 may transmit a trigger frame TR1, a trigger frame TR2, and a trigger frame TR3 to an electronic device 101, so that the electronic device 101 may sequentially transmit a packet SP1, a packet SP2, and a packet SP3 in response to the trigger frame TR1, the trigger frame TR2, and the trigger frame TR3. Thus, the communication system 100 may analyze channel information corresponding to the packet SP1, the packet SP2, and the packet SP3, and accordingly select a preferable antenna group to receive data subsequently transmitted by the electronic device 101. In some embodiments, the communication system 100 may operate as an access point, and the electronic device 101 may operate as a station, but the present disclosure is not limited thereto.

In some embodiments, the communication system 100 includes a transceiver circuit 110 and a controller circuit 120. The transceiver circuit 110 is connected to a transmitter antenna TX1, a transmitter antenna TX2, a transmitter antenna TX3, a receiver antenna RX1, a receiver antenna RX2, and a receiver antenna RX3, such that the communication system 100 is a communication system having a 3T3R transceiver mechanism. The transceiver circuit 110 may transmit signals to the electronic device 101 via the transmitter antenna TX1, the transmitter antenna TX2, and the transmitter antenna TX3, and may receive signals from the electronic device 101 via the receiver antenna RX1, the receiver antenna RX2, and the receiver antenna RX3. The transceiver circuit 110 may transmit, under control of the controller circuit 120, a plurality of trigger frames TR1, TR2, and TR3 sequentially to the electronic device 101.

In some embodiments, the controller circuit 120 may configure corresponding fields of the trigger frame TR1, the trigger frame TR2, and the trigger frame TR3 based on related standards of the IEEE 802.11ax protocol, so that the electronic device 101 may use specified transmission rates and corresponding numbers of spatial streams to sequentially transmit corresponding packets SP1, SP2, and SP3 based on to the trigger frame TR1, the trigger frame TR2, and the trigger frame TR3. For example, based on the IEEE 802.11ax protocol, the controller circuit 120 may configure data fields (such as a spatial stream allocation field and a modulation and coding scheme field) in the user information field of each of the trigger frames TR1, TR2, and TR3, so as to set the number of spatial streams and the data transmission rate used by the electronic device 101.

On the other hand, the controller circuit 120 may divide the receiver antennas RX1, RX2, and RX3 into a first antenna group (including the receiver antennas RX1 and RX2), a second antenna group (including the receiver antennas RX2 and RX3), and a third antenna group (including the receiver antennas RX1 and RX3), where each antenna group includes two antennas. As a result, the controller circuit 120 may configure the trigger frame TR1, so that the electronic device 101 may use two spatial streams (i.e., 2-SS) to transmit the packet SP1 in response to the trigger frame TR1. The controller circuit 120 may control the transceiver circuit 110 to receive the packet SP1 via the first antenna group (i.e., the receiver antennas RX1 and RX2), and analyze the packet SP1 to obtain first channel information corresponding to the first antenna group. Similarly, the controller circuit 120 may configure the trigger frame TR2, so that the electronic device 101 may use two spatial streams to transmit the packet SP2 in response to the trigger frame TR2. The controller circuit 120 may control the transceiver circuit 110 to receive the packet SP2 via the second antenna group (i.e., the receiver antennas RX2 and RX3), and analyze the packet SP2 to obtain second channel information corresponding to the second antenna group. The controller circuit 120 may configure the trigger frame TR3 so that the electronic device 101 may use two spatial streams to transmit the packet SP3 in response to the trigger frame TR3. The controller circuit 120 may control the transceiver circuit 110 to receive the packet SP3 via the third antenna group (i.e., the receiver antennas RX1 and RX3), and analyze the packet SP3 to obtain a third channel information corresponding to the third antenna group.

In some embodiments, each of the first, second, and third channel information mentioned above may include, but is not limited to, signal-to-noise ratio, condition number, and power delay profile. For example, the controller circuit 120 may determine information such as the signal-to-noise ratio, condition number, and power delay profile corresponding to the first antenna group according to the packet SP1, and output such information as the aforementioned first channel information. Similarly, the controller circuit 120 may determine information such as the signal-to-noise ratio, condition number, and power delay profile corresponding to the second antenna group according to the packet SP2, and output such information as the aforementioned second channel information. The controller circuit 120 may determine information such as the signal-to-noise ratio, condition number, and power delay profile corresponding to the third antenna group according to the packet SP3, and output such information as the aforementioned third channel information.

In some embodiments, the controller circuit 120 may determine a signal power (e.g., a received signal strength indication, RSSI) and a noise power of a channel corresponding to the first antenna group according to the packet SP1, so as to determine a signal-to-noise ratio corresponding to the first antenna group. In some embodiments, the controller circuit 120 may determine an error vector magnitude (EVM) of a channel corresponding to the first antenna group according to the packet SP1, and determine a signal-to-noise ratio corresponding to the first antenna group according to the error vector magnitude. In some embodiments, the controller circuit 120 may determine a channel gain of a channel corresponding to the first antenna group according to the packet SP1, and estimate a signal-to-noise ratio corresponding to the first antenna group according to the channel gain and the noise power. Similarly, the controller circuit 120 may determine a signal-to-noise ratio corresponding to the second antenna group according to the packet SP2, and may determine a signal-to-noise ratio corresponding to the third antenna group according to the packet SP3.

In some embodiments, the controller circuit 120 may determine a channel matrix corresponding to the first antenna group according to the packet SP1, and perform singular value decomposition on the channel matrix to obtain a maximum singular value and a minimum singular value of the channel matrix, and determine a condition number corresponding to the first antenna group according to the maximum singular value and the minimum singular value. In some embodiments, the controller circuit 120 may also perform QR decomposition on the channel matrix to obtain a triangular matrix, and calculate eigenvalues of the triangular matrix to determine a condition number corresponding to the first antenna group. Similarly, the controller circuit 120 may determine a condition number corresponding to the second antenna group according to the packet SP2, and may determine a condition number corresponding to the third antenna group according to the packet SP3.

In some embodiments, the controller circuit 120 may perform a correlation analysis between a known preamble and the received packet SP1 to estimate the distribution of signals arriving via different paths, and perform channel estimation according to the known preamble and the received signal to obtain a channel impulse response, which may indicate the distribution of signal strength over different delay paths, so as to obtain a power delay profile corresponding to the first antenna group. Similarly, the controller circuit 120 may determine a power delay profile corresponding to the second antenna group according to the packet SP2, and may determine a power delay profile corresponding to the third antenna group according to the packet SP3.

The above-mentioned types of information included in the channel information (such as the signal-to-noise ratio, the condition number, and the power delay profile) and the methods for determining those information are given for illustrative purposes, and the present disclosure is not limited thereto. Various kinds of information that can be used to assist in selecting a preferable receiving channel are within the contemplated scope of the present disclosure.

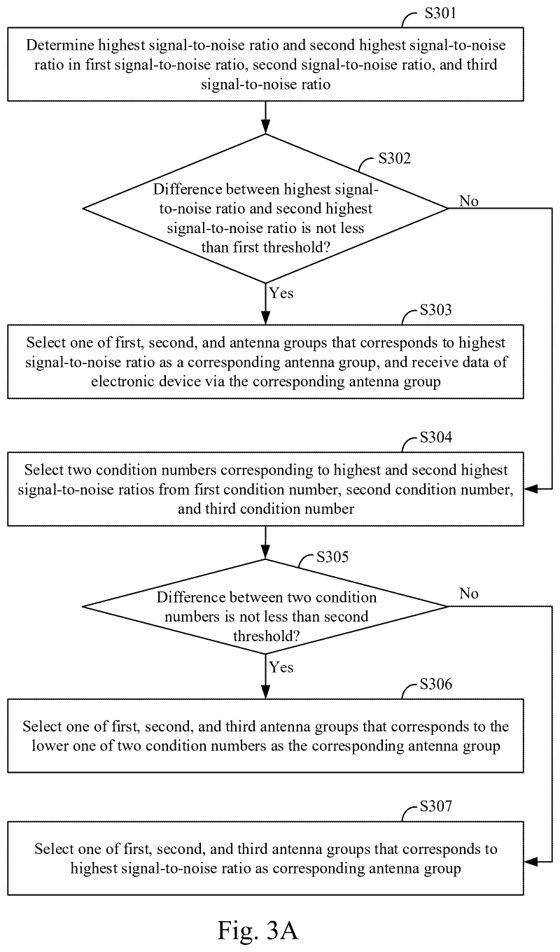

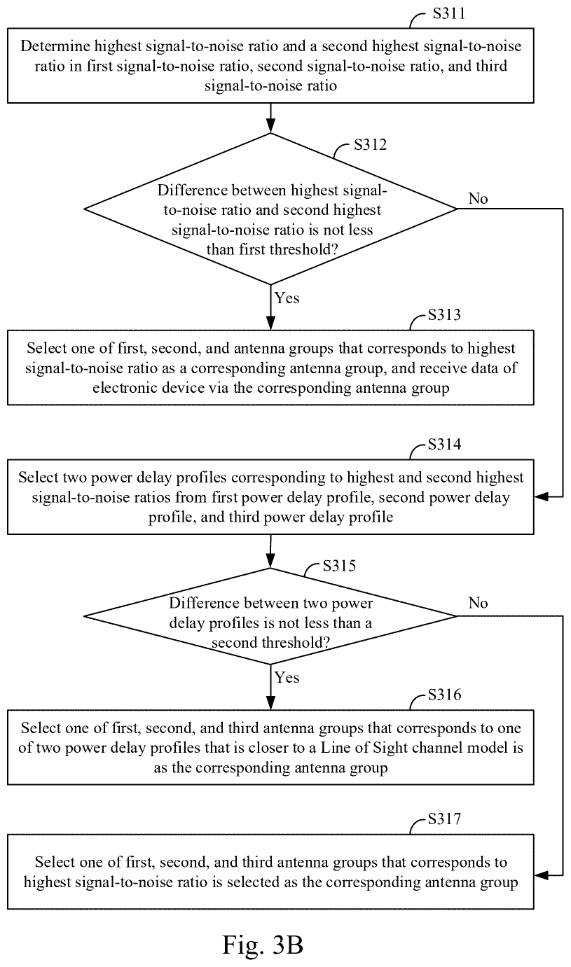

In some embodiments, the controller circuit 120 may be implemented with a digital signal processor circuit having computational capability, so as to perform the above operations to determine the corresponding first, second, and third channel information according to the packet SP1, the packet SP2, and the packet SP3. After obtaining the first, second, and third channel information, the controller circuit 120 may select a corresponding antenna group from the aforementioned first, second, and third antenna groups according to the first, second, and third channel information, so as to receive data from the electronic device 101 via the corresponding antenna group. The description regarding herein will be given later with reference to FIG. 3A and FIG. 3B.

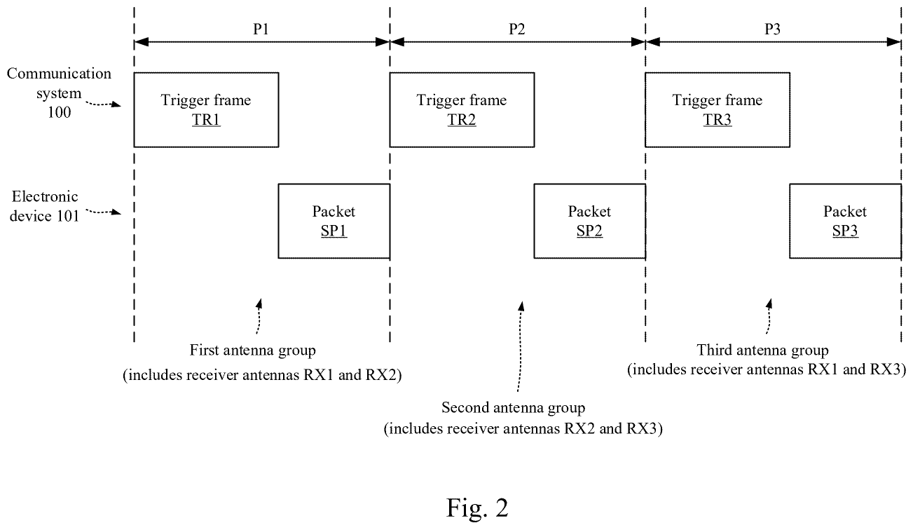

FIG. 2 illustrates a schematic timing diagram illustrating operations of exchanging trigger frames TR1, TR2, and TR3 and packets SP1, SP2, and SP3 between the communication system 100 and the electronic device 101 in FIG. 1 according to some embodiments of the present disclosure. During a period P1, the controller circuit 120 may control the transceiver circuit 110 to transmit the trigger frame TR1 to the electronic device 101, so that the electronic device 101 may use two spatial streams to transmit the packet SP1 in response to the trigger frame TR1. The controller circuit 120 may control the transceiver circuit 110 to receive the packet SP1 via a first antenna group (which includes the receiver antennas RX1 and RX2). Accordingly, the controller circuit 120 may determine first channel information corresponding to the first antenna group according to the packet SP1.

During a period P2, the controller circuit 120 may control the transceiver circuit 110 to transmit the trigger frame TR2 to the electronic device 101, so that the electronic device 101 may use spatial streams to transmit the packet SP2 in response to the trigger frame TR2. The controller circuit 120 may control the transceiver circuit 110 to receive the packet SP2 via a second antenna group (which includes the receiver antennas RX2 and RX3). Accordingly, the controller circuit 120 may determine second channel information corresponding to the second antenna group according to the packet SP2.

During a period P3, the controller circuit 120 may control the transceiver circuit 110 to transmit the trigger frame TR3 to the electronic device 101, so that the electronic device 101 may use two spatial streams to transmit the packet SP3 in response to the trigger frame TR3. The controller circuit 120 may control the transceiver circuit 110 to receive the packet SP3 via a third antenna group (which includes the receiver antennas RX1 and RX3). Accordingly, the controller circuit 120 may determine a third channel information corresponding to the third antenna group according to the packet SP3.

With the above operations, the controller circuit 120 may quickly select a preferable corresponding antenna group from the first antenna group, the second antenna group, and the third antenna group according to the multiple packets SP1, SP2, and SP3, so as to use the corresponding antenna group to receive subsequent data from the electronic device 101. With this analogy, the controller circuit 120 may perform the above operations to identify a suitable antenna combination for other electronic devices located at different positions, thereby improving the reception capability for each electronic device.

In some related approaches, an existing communication device needs to use different antenna combinations to receive packets returned by the electronic device over a relatively long period, and performs statistical analysis on all packets received during that period to select the antenna to be used subsequently. As such, a longer processing time is spent on information collection and statistical analysis, which lowers the efficiency of antenna selection. In some embodiments of the present disclosure, the communication system 100 may transmit specific trigger frames to the electronic device over several consecutive periods, so as to request the electronic device to use a specified number of spatial streams and transmission rates to transmit packets, thereby enabling the communication system 100 to obtain these packets within a shorter period and to select a suitable antenna combination accordingly. In addition, compared to the above related approaches, the number of packets that the communication system 100 needs to process may also be significantly reduced. For example, in the above operations, the controller circuit 120 may determine the channel information of the first antenna group according to a single packet SP1. On the contrary, the related approaches require statistical analysis on multiple packets within a certain period to determine the reception performance of an antenna combination. As a result, the communication system 100 may select a suitable antenna combination more efficiently.

FIG. 3A illustrates a flowchart illustrating an operation of the controller circuit 120 in FIG. 1 for determining a corresponding antenna group according to the first channel information, the second channel information, and the third channel information according to some embodiments of the present disclosure. In this example, the first channel information determined by the controller circuit 120 according to the packet SP1 (which corresponds to the first antenna group) includes a first signal-to-noise ratio and a first condition number. The second channel information determined by the controller circuit 120 according to the packet SP2 (which corresponds to the second antenna group) includes a second signal-to-noise ratio and a second condition number. The third channel information determined by the controller circuit 120 according to the packet SP3 (which corresponds to the third antenna group) includes a third signal-to-noise ratio and a third condition number.

In operation S301, a highest signal-to-noise ratio and a second highest signal-to-noise ratio in the first signal-to-noise ratio, the second signal-to-noise ratio, and the third signal-to-noise ratio are determined. In operation S302, whether a difference between the highest signal-to-noise ratio and the second highest signal-to-noise ratio is not less than a first threshold is determined. If the difference is not less than the first threshold, operation S303 is performed. Alternatively, if the difference is less than the first threshold, operation S304 is performed. In operation S303, one of the first, second, and third antenna groups that corresponds to the highest signal-to-noise ratio is selected as a corresponding antenna group, and data of the electronic device is received via the corresponding antenna group.

For example, if the first signal-to-noise ratio is higher than the second signal-to-noise ratio, and the second signal-to-noise ratio is higher than the third signal-to-noise ratio, the controller circuit 120 may determine that the first signal-to-noise ratio is the highest signal-to-noise ratio, and the second signal-to-noise ratio is the second highest signal-to-noise ratio. Afterwards, the controller circuit 120 may determine whether the difference between the first signal-to-noise ratio and the second signal-to-noise ratio is not less than the first threshold. In some embodiments, the first threshold may be approximately 10 decibels (dB), but the present disclosure is not limited thereto. If the difference between the first signal-to-noise ratio and the second signal-to-noise ratio is not less than the first threshold, the controller circuit 120 may select the first antenna group corresponding to the first signal-to-noise ratio as the corresponding antenna group, and receive subsequent data transmitted by the electronic device 101 via the first antenna group.

With continued reference to FIG. 3A, in operation S304, two condition numbers corresponding to the highest and the second highest signal-to-noise ratios are selected from the first condition number, the second condition number, and the third condition number. In operation S305, whether a difference between the two condition numbers is not less than a second threshold is determined. If the difference between the two condition numbers is not less than the second threshold, operation S306 is performed. Alternatively, if the difference between the two condition numbers is less than the second threshold, operation S307 is performed. In operation S306, one of the first, second, and third antenna groups that corresponds to the lower one of the two condition numbers is selected as the corresponding antenna group. In operation S307, one of the first, second, and third antenna groups that corresponds to the highest signal-to-noise ratio is selected as the corresponding antenna group.

With continued reference to the above example, if the difference between the first signal-to-noise ratio and the second signal-to-noise ratio is less than the first threshold, the controller circuit 120 may further perform antenna selection according to the first condition number, the second condition number, and the third condition number. In this example, the first signal-to-noise ratio and the second signal-to-noise ratio are respectively the highest and second highest signal-to-noise ratios, the first signal-to-noise ratio and the first condition number both correspond to the first antenna group, and the second signal-to-noise ratio and the second condition number both correspond to the second antenna group. Therefore, the controller circuit 120 selects the first condition number and the second condition number from the first, second, and third condition numbers according to the first and second signal-to-noise ratios, and determines whether a difference between the first condition number and the second condition number (an absolute value of the difference may be taken, though the present disclosure is not limited thereto) is not less than the second threshold.

If the first condition number is lower than the second condition number, and the difference between the two is not less than the second threshold, the controller circuit 120 may thus select, from the first, second, and third antenna groups, the first antenna group corresponding to the first condition number (which is the lower one of the two condition numbers) as the corresponding antenna group. Alternatively, if the difference between the first condition number and the second condition number is less than the second threshold, the controller circuit 120 may again perform determination according to the signal-to-noise ratio. In this example, the controller circuit 120 may select, from the first, second, and third antenna groups, the first antenna group corresponding to the highest signal-to-noise ratio (e.g., the first signal-to-noise ratio) as the corresponding antenna group. In other words, in some embodiments, the signal-to-noise ratio may be one of the factors given priority.

FIG. 3B illustrates a flowchart illustrating an operation of the controller circuit 120 in FIG. 1 for determining a corresponding antenna group according to the first channel information, the second channel information, and the third channel information according to some embodiments of the present disclosure. In this example, the first channel information determined by the controller circuit 120 according to the packet SP1 (which corresponds to the first antenna group) includes a first signal-to-noise ratio and a first power delay profile; the second channel information determined by the controller circuit 120 according to the packet SP2 (which corresponds to the second antenna group) includes a second signal-to-noise ratio and a second power delay profile; and the third channel information determined by the controller circuit 120 according to the packet SP3 (which corresponds to the third antenna group) includes a third signal-to-noise ratio and a third power delay profile.

In operation S311, a highest signal-to-noise ratio and a second highest signal-to-noise ratio in the first signal-to-noise ratio, the second signal-to-noise ratio, and the third signal-to-noise ratio are determined. In operation S312, whether a difference between the highest signal-to-noise ratio and the second highest signal-to-noise ratio is not less than a first threshold is determined. If the difference is not less than the first threshold, operation S313 is performed. Alternatively, if the difference is less than the first threshold, operation S314 is performed. In operation S313, one of the first, second, and third antenna groups that corresponds to the highest signal-to-noise ratio is selected as a corresponding antenna group, and data of the electronic device is received via the corresponding antenna group. Operations S311 to S313 are the same as operations S301 to S303 in FIG. 3A, and thus are not repeated here.

In operation S314, two power delay profiles corresponding to the highest and second highest signal-to-noise ratios are selected from the first power delay profile, the second power delay profile, and the third power delay profile. In operation S315, whether a difference between the two power delay profiles is not less than a second threshold is determined. If the difference between the two power delay profiles is not less than the second threshold, operation S316 is performed. Alternatively, if the difference between the two power delay profiles is less than the second threshold, operation S317 is performed. In operation S316, one of the first, second, and third antenna groups that corresponds to the one of the two power delay profiles that is closer to a Line of Sight (LOS) channel model is selected as the corresponding antenna group. In operation S317, one of the first, second, and third antenna groups that corresponds to the highest signal-to-noise ratio is selected as the corresponding antenna group.

With continued reference to the above example, the first signal-to-noise ratio and the second signal-to-noise ratio are respectively the highest and second highest signal-to-noise ratios, the first signal-to-noise ratio and the first condition number both correspond to the first antenna group, and the second signal-to-noise ratio and the second condition number both correspond to the second antenna group. Therefore, the controller circuit 120 may select the first power delay profile and the second power delay profile from the first, second, and third power delay profiles according to the first and second signal-to-noise ratios, and determine whether the difference between the first power delay profile and the second power delay profile is not less than the second threshold. If the difference between the two power delay profiles is not less than the second threshold, the controller circuit 120 may determine which of the first and second power delay profiles is closer to the Line of Sight (LOS) channel model, and select the antenna group corresponding to the one that is closer to the LOS channel model as the corresponding antenna group. For example, if the first power delay profile is closer to the LOS channel model than the second power delay profile, the controller circuit 120 may select the first antenna group corresponding to the first power delay profile as the corresponding antenna group. On the other hand, if the difference between the two power delay profiles is less than the second threshold, the controller circuit 120 may again perform determination according to the signal-to-noise ratio. In this example, the controller circuit 120 may select, from the first, second, and third antenna groups, the first antenna group corresponding to the highest signal-to-noise ratio (e.g., the first signal-to-noise ratio) as the corresponding antenna group.

With continued reference to the above example, the first signal-to-noise ratio and the second signal-to-noise ratio are respectively the highest and second highest signal-to-noise ratios, the first signal-to-noise ratio and the first condition number both correspond to the first antenna group, and the second signal-to-noise ratio and the second condition number both correspond to the second antenna group. Therefore, the controller circuit 120 may select the first power delay profile and the second power delay profile from the first, second, and third power delay profiles according to the first and second signal-to-noise ratios, and determine whether the difference between the first power delay profile and the second power delay profile is not less than the second threshold. If the difference between the two power delay profiles is not less than the second threshold, the controller circuit 120 may determine which of the first and second power delay profiles is closer to the Line of Sight (LOS) channel model, and select the antenna group corresponding to the one that is closer to the LOS channel model as the corresponding antenna group. For example, if the first power delay profile is closer to the LOS channel model than the second power delay profile, the controller circuit 120 may select the first antenna group corresponding to the first power delay profile as the corresponding antenna group. On the other hand, if the difference between the two power delay profiles is less than the second threshold, the controller circuit 120 may again perform determination according to the signal-to-noise ratio. In this example, the controller circuit 120 may select, from the first, second, and third antenna groups, the first antenna group corresponding to the highest signal-to-noise ratio (e.g., the first signal-to-noise ratio) as the corresponding antenna group.

In some embodiments, the controller circuit 120 may perform correlation analysis between the first power delay profile and the second power delay profile to determine the difference therebetween. In some embodiments, the controller circuit 120 may compare the main energy concentration of the first power delay profile with that of the second power delay profile to determine the difference therebetween. In some embodiments, the controller circuit 120 may perform Fourier transforms according to the first power delay profile and the second power delay profile to analyze spectral energy distributions thereof, so as to determine the difference between the first power delay profile and the second power delay profile. Similarly, the controller circuit 120 may determine which of the first and second power delay profiles is closer to the Line of Sight (LOS) channel model according to the aforementioned calculations. In general, if the energy of a power delay profile is more concentrated on the shortest delay path, or if the spectral energy distribution is smoother (i.e., the signal energy varies more uniformly with frequency), this indicates that the power delay profile is closer to the LOS channel model. The above methods of analyzing power delay profiles are given for illustrative purposes, and the present disclosure is not limited thereto.

The above example is given with the communication system 100 in FIG. 1 being a communication device having a 3T3R transceiver mechanism. However, the present disclosure is not limited to the number of antennas shown in FIG. 1. It should be understood that the antenna selection mechanism described above may be applied to communication systems having a plurality of receiver antennas. The operations shown in FIG. 3A and/or FIG. 3B are given for illustrative purposes, and the present disclosure is not limited thereto. In some embodiments, the signal-to-noise ratio, condition number, power delay profile, and/or other types of channel state parameters may be comprehensively considered to perform antenna group selection.

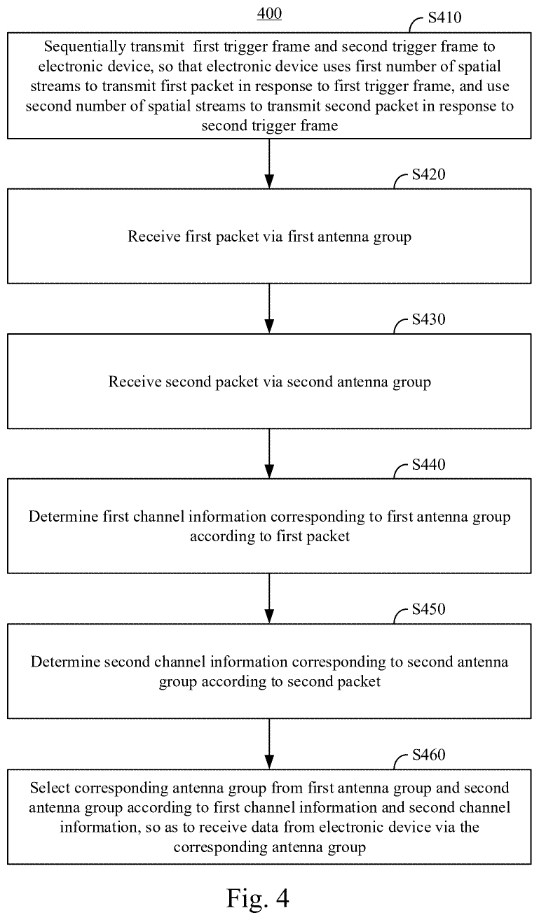

FIG. 4 illustrates a flowchart illustrating an antenna selection method 400 according to some embodiments of the present disclosure. In some embodiments, the antenna selection method 400 may be performed by, but is not limited to, the communication system 100 shown in FIG. 1.

In operation S410, a first trigger frame and a second trigger frame are sequentially transmitted to an electronic device, so that the electronic device uses a first number of spatial streams to transmit a first packet in response to the first trigger frame, and uses a second number of spatial streams to transmit a second packet in response to the second trigger frame. In operation S420, the first packet is received via a first antenna group. In operation S430, the second packet is received via a second antenna group. In operation S440, first channel information corresponding to the first antenna group is determined according to the first packet. In operation S450, second channel information corresponding to the second antenna group is determined according to the second packet. In operation S460, a corresponding antenna group is selected from the first antenna group and the second antenna group according to the first channel information and the second channel information, so as to receive data from the electronic device via the corresponding antenna group.

The above operations may be understood with reference to the aforementioned embodiments, and thus the repetitious descriptions are not further given. Operations in the antenna selection method 400 are merely exemplary and are not limited to being performed in the sequence presented. Without departing from the operational methods and scope of the embodiments of the present disclosure, Operations in the antenna selection method 400 may be appropriately added, replaced, omitted, or executed in a different order. Alternatively, operations in FIG. 3A, FIG. 3B, and/or FIG. 4 may be performed simultaneously or partially simultaneously.

As described above, the communication system and the antenna selection method provided in some embodiments of the present disclosure may actively transmit trigger frames to request a device end to use a specified number of spatial streams to transmit packets, so that the communication system may efficiently select an antenna group suitable for receiving data from the device end according to the packets received via multiple antenna groups, thereby improving overall reception performance.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely the preferred embodiments of the present disclosure, without any intention to limit the scope of the present disclosure thereto. Various equivalent changes, alterations, or modifications according to the claims of the present disclosure are all consequently viewed as being embraced by the scope of the present disclosure.

What is claimed is:

1. A communication system, comprising:
a transceiver circuit configured to sequentially transmit a first trigger frame and a second trigger frame to an electronic device, so that the electronic device uses a first number of spatial streams to transmit a first packet in response to the first trigger frame, and uses a second number of spatial streams to transmit a second packet in response to the second trigger frame,
wherein the transceiver circuit receives the first packet via a first antenna group and receives the second packet via a second antenna group; and
a controller circuit configured to determine first channel information corresponding to the first antenna group according to the first packet, determine second channel information corresponding to the second antenna group according to the second packet, and select a corresponding antenna group from the first antenna group and the second antenna group according to the first channel information and the second channel information, so as to receive data from the electronic device via the corresponding antenna group.

2. The communication system of claim 1, wherein the first channel information comprises a first signal-to-noise ratio, the second channel information comprises a second signal-to-noise ratio, and the controller circuit is configured to select the corresponding antenna group according to the first signal-to-noise ratio and the second signal-to-noise ratio.

3. The communication system of claim 2, wherein when the first signal-to-noise ratio is a highest one of the first signal-to-noise ratio and the second signal-to-noise ratio, and a difference between the first signal-to-noise ratio and the second signal-to-noise ratio is not less than a first threshold, the controller circuit is configured to select the first antenna group as the corresponding antenna group.

4. The communication system of claim 2, wherein the first channel information further comprises a first condition number, the second channel information comprises a second condition number, and when a difference between the first signal-to-noise ratio and the second signal-to-noise ratio is less than a first threshold, the controller circuit is further configured to select the corresponding antenna group according to the first condition number and the second condition number.

5. The communication system of claim 4, wherein when the first condition number is lower than the second condition number, and a difference between the second condition number and the first condition number is not less than a second threshold, the controller circuit is further configured to select the first antenna group as the corresponding antenna group.

6. The communication system of claim 5, wherein when the first condition number is lower than the second condition number, and the difference between the second condition number and the first condition number is less than the second threshold, the controller circuit is further configured to compare the first signal-to-noise ratio with the second signal-to-noise ratio, and to select the first antenna group as the corresponding antenna group when the first signal-to-noise ratio is a highest one of the first signal-to-noise ratio and the second signal-to-noise ratio.

7. The communication system of claim 2, wherein the first channel information further comprises a first power delay profile, the second channel information comprises a second power delay profile, and when a difference between the first signal-to-noise ratio and the second signal-to-noise ratio is less than a first threshold, the controller circuit is further configured to select the corresponding antenna group according to the first power delay profile and the second power delay profile.

8. The communication system of claim 7, wherein when the first power delay profile is closer to a Line of Sight (LOS) channel model than the second power delay profile, the controller circuit is configured to select the first antenna group as the corresponding antenna group.

9. The communication system of claim 7, wherein when a difference between the first power delay profile and the second power delay profile is less than a second threshold, the controller circuit is further configured to compare the first signal-to-noise ratio with the second signal-to-noise ratio, and to select the first antenna group as the corresponding antenna group when the first signal-to-noise ratio is a highest one of the first signal-to-noise ratio and the second signal-to-noise ratio.

10. An antenna selection method, comprising:
sequentially transmitting a first trigger frame and a second trigger frame to an electronic device, so that the electronic device uses a first number of spatial streams to transmit a first packet in response to the first trigger frame, and uses a second number of spatial streams to transmit a second packet in response to the second trigger frame;
receiving the first packet via a first antenna group;
receiving the second packet via a second antenna group;
determining first channel information corresponding to the first antenna group according to the first packet;
determining second channel information corresponding to the second antenna group according to the second packet; and
selecting a corresponding antenna group from the first antenna group and the second antenna group according to the first channel information and the second channel information, so as to receive data from the electronic device via the corresponding antenna group.

11. The antenna selection method of claim 10, wherein the first channel information comprises a first signal-to-noise ratio, the second channel information comprises a second signal-to-noise ratio, and selecting the corresponding antenna group from the first antenna group and the second antenna group according to the first channel information and the second channel information to receive the data from the electronic device via the corresponding antenna group comprises:
selecting the corresponding antenna group according to the first signal-to-noise ratio and the second signal-to-noise ratio.

12. The antenna selection method of claim 11, wherein selecting the corresponding antenna group according to the first signal-to-noise ratio and the second signal-to-noise ratio comprises:
when the first signal-to-noise ratio is a highest one of the first signal-to-noise ratio and the second signal-to-noise ratio, and a difference between the first signal-to-noise ratio and the second signal-to-noise ratio is not less than a first threshold, selecting the first antenna group as the corresponding antenna group.

13. The antenna selection method of claim 11, wherein the first channel information further comprises a first condition number, the second channel information comprises a second condition number, and selecting the corresponding antenna group according to the first signal-to-noise ratio and the second signal-to-noise ratio comprises:
when a difference between the first signal-to-noise ratio and the second signal-to-noise ratio is less than a first threshold, selecting the corresponding antenna group according to the first condition number and the second condition number.

14. The antenna selection method of claim 13, wherein selecting the corresponding antenna group according to the first condition number and the second condition number comprises:
when the first condition number is lower than the second condition number, and a difference between the second condition number and the first condition number is not less than a second threshold, selecting the first antenna group as the corresponding antenna group.

15. The antenna selection method of claim 14, wherein selecting the corresponding antenna group according to the first condition number and the second condition number comprises:
when the first condition number is lower than the second condition number, and the difference between the second condition number and the first condition number is less than the second threshold, comparing the first signal-to-noise ratio with the second signal-to-noise ratio, and selecting the first antenna group as the corresponding antenna group when the first signal-to-noise ratio is a highest one of the first signal-to-noise ratio and the second signal-to-noise ratio.

16. The antenna selection method of claim 11, wherein the first channel information further comprises a first power delay profile, the second channel information comprises a second power delay profile, and selecting the corresponding antenna group according to the first signal-to-noise ratio and the second signal-to-noise ratio comprises:
when a difference between the first signal-to-noise ratio and the second signal-to-noise ratio is less than a first threshold, selecting the corresponding antenna group according to the first power delay profile and the second power delay profile.

17. The antenna selection method of claim 16, wherein selecting the corresponding antenna group according to the first power delay profile and the second power delay profile comprises:
when the first power delay profile is closer to a Line of Sight (LOS) channel model than the second power delay profile, selecting the first antenna group as the corresponding antenna group.

18. The antenna selection method of claim 16, wherein selecting the corresponding antenna group according to the first power delay profile and the second power delay profile comprises:
when a difference between the first power delay profile and the second power delay profile is less than a second threshold, comparing the first signal-to-noise ratio with the second signal-to-noise ratio, and selecting the first antenna group as the corresponding antenna group when the first signal-to-noise ratio is a highest one of the first signal-to-noise ratio and the second signal-to-noise ratio.
